(19) United States
(12) Patent Application Publication
(10) Pub. No.: US 2025/0192491 A1
(43) Pub. Date: Jun. 12, 2025

(54) SYSTEM FOR A PRESENTATION, SALES OR EXHIBITION STAND AND/OR FOR SHOP FITTING AND CURRENT COLLECTOR FOR AN ELECTRICAL LOAD IN A SYSTEM OF THIS KIND, AND USE OF SAME

(71) Applicant: MAGNWALL GMBH, Weinstadt (DE)

(72) Inventors: Klaus-Dieter FELD, Weinstadt (DE); Matthias RIETSCHEL, Friolzheim (DE)

(73) Assignee: MAGNWALL GMBH, Weinstadt (DE)

(21) Appl. No.: 18/720,562

(22) PCT Filed: Dec. 14, 2022
(86) PCT No.: PCT/EP2022/085798

§ 371 Date: Jan. 13, 2025

(30) Foreign Application Priority Data
Dec. 14, 2021 (DE) 10 2021 133 113.7

(51) Int. Cl. H01R 25/14; H01R 4/2433; H01R 13/24; H01R 13/436; H01R 13/62

(52) U.S. Cl. CPC H01R 25/145; H01R 4/2433; H01R 13/2421; H01R 13/4365; H01R 13/6205; H01R 25/142

(57) ABSTRACT

The invention relates to a system for a presentation, sales or exhibition stand and/or for shop fitting, comprising a current-conducting wall element and a current collector for an electrical load and secured to the wall element. The wall element comprises a carrier plate and a coating covering same, a first and a second electrical conductor tracks being arranged alternately at least in some sections. The current collector comprises a number of at least two contact needles, particularly of at least three contact needles. The current collector is secured to the wall element in such a way that at least one of the contact needles contacts one of the first electrical conductor tracks and at least one other of the contact needles contacts one of the second electrical conductor tracks.

The present invention relates to a system or presentation system, particularly for a presentation, sales or exhibition stand and/or for shop construction, and a current collector for an electrical consumer. The proposed presentation system can also be used in museums or in the smart home sector.

A presentation or exhibition stand is the first point of contact for a new customer and is therefore important as a showcase for the presenting company. For this reason, particular attention is being paid to the visual impression and also to the possibilities of different and, in particular, flexible presentations. As a special eye-catcher, special electrical consumers such as lighting equipment or monitors etc. are increasingly being used on wall, floor or ceiling elements of presentation, trade fair or sales stands, but also in shopfitting, to draw the viewer's attention to certain things. However, the arrangement of such lighting devices or electrical consumers in general has so far required cabling, which severely limits flexibility with regard to a modified arrangement of the electrical consumer or the lighting device. In the same way, there is increasing emphasis on an attractive appearance in shop design.

DE 10 2011 005 735 A1 discloses a system for a presentation, sales or trade fair stand and/or for shopfitting with at least one wall, floor or ceiling element with a carrier material and a coating covering it, wherein electrical conductor tracks are applied to the carrier material or arranged on/in the coating and wherein the carrier material and/or the electrical conductor tracks are magnetizable, i.e. have ferromagnetic properties; and with at least one electrical consumer which has At least one magnet can be fixed to the carrier material, the electrical consumer having needle-shaped current collectors which penetrate the coating when an electrical consumer is fixed to the carrier material and thus establish electrical contact with the conductor tracks and supply the electrical consumer with power.

This system known from DE 10 2011 005 735 A1 makes it possible, for example, to create a wall element, for example for a presentation, sales or exhibition stand or for shop construction, which in particular enables an easily changeable and therefore flexible arrangement of electrical consumers on the wall element.

DE 10 2018 115 659 B4 discloses a system for a presentation, sales or exhibition stand and/or for shop construction with a current-carrying wall element and a current collector for an electrical consumer which is designed to be fastened to the wall element; wherein the wall element has a carrier plate and a coating covering this; wherein the wall element has first electrical conductor tracks of a first polarity and second electrical conductor tracks of a second has polarity, wherein the first and second electrical conductor tracks are arranged alternately at least in sections; wherein the current collector has a plurality of at least three contact needles, wherein the current collector is set up to be fastened to the wall element in such a way that at least one of the contact needles contacts one of the first electrical conductor tracks and at least one other of the contact needles contacts one of the second electrical conductor tracks; and wherein a first contact needle, a second contact needle, and a third contact needle of the plurality of contact needles are arranged in such a way that they lie on a circle. DE 10 2018 115 659 B4 also discloses a corresponding current collector.

The solution described in DE 10 2018 115 659 B4 is intended to enable a freely selectable and flexibly variable positioning of an electrical consumer on a wall element in a simple manner.

Against this background, it is an object of the present disclosure to provide a further improved system for a presentation, sales or exhibition stand and/or for shopfitting. In particular, it would be desirable to further improve the reliability and/or lifetime of such systems.

According to a first aspect of the present disclosure, a system, in particular for a presentation, sales or exhibition stand and/or for shopfitting, is therefore proposed with
a current-carrying wall element and
a current collector for an electrical consumer, which also is designed to be attached to the wall element;
wherein the wall element comprises a carrier plate and a coating covering it;
wherein the wall element comprises first electrical conductor tracks (of a first polarity) and second electrical conductor tracks (of a second polarity), the first and second electrical conductor tracks being arranged alternately at least in sections;
wherein the current collector has a plurality of at least two contact needles, in particular of at least three contact needles,
wherein the current collector is set up to be fastened to the wall element in such a way that at least one of the contact needles contacts one of the first electrical conductor tracks and at least one other of the contact needles contacts one of the second electrical conductor tracks; and
wherein the current collector comprises replaceable contact needles.

According to a second aspect of the present disclosure, a corresponding current collector for an electrical load (for use) in a system for a presentation, sales or exhibition stand and/or for shopfitting is proposed.

According to a further aspect of the present disclosure, the use of such a current collector in such a system is proposed for a presentation, sales or exhibition stand and/or for shopfitting.

According to a further aspect, a corresponding method is proposed for or for equipping a presentation, sales or exhibition stand and/or for shopfitting.

In practice, it has been shown that a system for a presentation, sales or exhibition stand and/or for shopfitting, as described in DE 10 2018 115 659 B4, invites and encourages people to playfully try out different positions of electrical consumers, for example frequently redecorating a shop window. Electrical consumers are moved several times to different positions in order to achieve the desired effect and to stage the objects to be presented in the best possible way. The inventors have recognized that the contact needles should preferably be made very thin so as not to leave any visible traces when penetrating materials or coatings of wall elements. In addition, the use of thin needles makes it easier to penetrate coatings made of a wide variety of materials. The inventors have also recognized that this requirement is contrary to providing a product that is as sustainable and long-lasting as possible, as current collectors with thin contact needles have a limited lifespan. For the highest possible mechanical stability, the contact needles should be made thicker and more stable. It would therefore be desirable to have a further improved system for a presentation, sales or exhibition stand and/or for shopfitting that strengthens the conscious use of limited resources. In particular, it would be desirable to further improve the reliability and/or lifetime of such systems.

According to the present disclosure, it is therefore proposed to provide a system, in particular for a presentation, sales or exhibition stand and/or for shop fitting, with a current-carrying wall element and a current collector for an electrical consumer, which is designed to be attached to the wall element, wherein the wall element has a carrier plate and a cover covering it, wherein the current collector has replaceable contact needles. In the specific context of such a system for a presentation, sales or exhibition stand and/or for shopfitting, no such current collector with replaceable contact pins, designed to penetrate the coating covering the carrier plate, has yet been described.

The proposed solution is based on the general idea that a current-carrying wall serves as a source and an adapter or current collector is provided to draw electricity from the wall. The wall element can be designed to be connected to a current or voltage source such as a power supply. The first conductor tracks can be connected, for example, via a first rear terminal contact to a positive pole, and the second conductor tracks, for example, via a second rear terminal contact to a negative pole. For example, a DC voltage of 12V or 24V can be provided. Alternatively, another type of voltage supply, such as an AC voltage or a DC voltage with a superimposed AC voltage, can be provided via the first and second conductor tracks. The wall element can have a carrier plate and, optionally, a coating covering it. The combination of carrier plate and cover is particularly advantageous for such presentation stands, since a cover can be changed quickly and the stand can be easily customized. The coating can extend over a wall element or a group of wall elements. For example, such a coating can be printed and/or labelled. The current collector and/or the electrical consumer may be designed to be attached to the wall element. Power can also be supplied via a current-carrying mounting rail arrangement, as described in DE 10 2020 104 017 A1. The disclosure of DE 10 2020 104 017 A1 is incorporated by reference. The current-carrying mounting rail arrangement can be designed, on the one hand, to hold the wall element and, on the other hand, to supply power via the first electrical connection contact and the second electrical connection contact on the rear side of the carrier plate.

The conductor tracks of the electrical wall element may be an integral part of the carrier element, for example, in the form of a punched steel plate, and may be arranged on the carrier material and/or on/in the coating. It goes without saying that a wall element can also have a layered structure. Such a layered structure may have one or more of the following layers: a supporting structure such as wood or metal, a layer of a magnetic or magnetizable material such as steel, an insulation layer, and a conductor track layer, for example of a (thin) metal foil. For example, a carrier plate or support structure, such as plastic, can be provided, on which a layer of a magnetic or magnetizable material, such as steel, is applied, which can optionally also be designed as a first and/or second conductor track at the same time, and optionally a coating can be provided. The use of a layered magnetic or ferromagnetic material is advantageous since a current collector or consumer can be flexibly attached to the wall element by means of magnets.

The current collector has a plurality of at least two or at least three contact needles, for example exactly three or exactly four. The current collector is set up so that it can be attached to the wall element in such a way that at least one of the contact needles contacts one of the first electrical conductor tracks and at least one other of the contact needles contacts one of the second electrical conductor tracks. For example, if the conductor tracks are arranged on the carrier plate of the wall element and the wall element has a coating covering the carrier plate, the contact needles may be designed to penetrate the coating and establish a connection with the respective conductor tracks. The contact needles can pierce through or into the wall element. The electrical conductor paths could also be integrated into the coating, particularly woven into it. In principle, the current collector can be set up to establish an electrical connection to the first and second conductor tracks when placed on the wall element and to supply the tapped voltage to a consumer.

Advantages of the proposed solution compared to conventional shop or exhibition construction may in particular be that complex cabling of the individual electrical consumers attached to the presentation element can be omitted. Instead, consumers can be flexibly attached to the presentation element on-the-fly. Expensive corrections can therefore be omitted. In addition, it encourages creativity, as the individual consumers can be repositioned and reorganized flexibly, particularly with regard to their rotation relative to the wall element. In a sense, such a system invites you to play and experiment with the arrangement of electrical consumers in order to achieve the most appealing presentation result possible. In particular, the current-carrying wall element can be supplied with electricity even before the consumers are attached and the result can be examined immediately. There is no need for complex rewiring.

It is understood that the current collector can either be attached as such to the wall element and the tapped current can be supplied to a consumer, for example by cable, or can be integrated into a holder or an electrical consumer.

A system for a presentation, sales or exhibition stand and/or for shopfitting can also be referred to as a display stand. A wall element within the scope of the present invention may also relate to a floor element or a ceiling element. In the context of the present invention, a contact needle can also be understood as a contact pin or contact pin which does not necessarily have a tapered tip. The contact needles can be arranged in such a way that they or the tips or ends of the contact needles lie in one plane. Optionally, the contact needles can be spring-loaded. The contact needles may be designed to penetrate the coating. In the context of the present invention, an equilateral or equilateral triangle can optionally be understood as a triangle in which the lengths of the legs or sides differ by no more than 20%, preferably by no more than 10%, preferably by no more than 5%, in each case relative to one of the other legs or one of the other sides.

In one configuration, the current collector can have a base body and a needle holder, wherein the needle holder has the contact needles; and wherein the needle holder and is interchangeable with the contact needles. One advantage of this solution is that the contact needles do not have to be replaced individually but instead the needle holder with the contact needles. This can make for easier handling and faster replacement of damaged contact needles.

The current collector can have a locking mechanism for detachable attachment of the needle holder to the base body. The locking mechanism may be part of the replaceable needle holder. In this case, even if the locking mechanism is damaged, the entire current collector is not necessarily unusable. For example, a detachable locking mechanism may be provided. The needle holder may have a turnstile which engages in recesses on the base body to lock in place. The locking mechanism may, for example, have a screw cap; in particular, the screw cap has a slot-shaped recess for operation. This type of screw cap can be operated in a simple manner, for example with a coin.

The current collector can be set up in such a way that the needle holder can be attached to the base body without tools. This can make it easier to replace the needle holder with the contact needles.

The current collector may have electrically conductive spring pins which are designed to provide an electrical connection between the contact needles of the needle holder, in particular the rear ends of the contact needles of the needle holder, and electrical contacts of the base body. The spring pins may be part of the base body or part of the needle holder. One advantage of this solution may be that reliable electrical contact can be established with contacts on the base body. The electrical consumer can be supplied with energy directly or indirectly via electrical contacts on the base body. For example, the current collector may have an interconnected rectifier to provide an output voltage of defined polarity.

The electrically conductive spring pins may also be designed to raise the needle holder relative to the main body for easier removal or replacement. One advantage of this solution can be seen in a synergy effect that the electrically conductive spring pins, on the one hand, establish electrical contact between base body and needle holder and also facilitate removal of the needle holder from the base body. When a locking mechanism for detachably securing the needle holder to the base body is released, the needle holder can be lifted relative to the base body by means of the electrically conductive spring pins and thus make it easier to remove the needle holder during replacement. A new needle holder can then be used. The new needle holder with new contact needles can be lowered against the spring tension of the spring pins and attached to the base body by means of a locking mechanism. Another synergy effect may be that the lock can be more stable when the spring pins press the needle holder against the base body in a locked state and require increased frictional force to release the locking mechanism.

In a further development, the main body may have a circuit board on which the electrically conductive spring pins are arranged. The electrically conductive spring pins can be glued or soldered onto the circuit board of the base body. Soldered spring pins are particularly advantageous since both a mechanical and electrical connection can be provided and the spring pins can be easily attached when producing the circuit board of the base body of the current collector. In the proposed embodiment, the electrically conductive spring pins only represent an intermediate element within the current collector in order to establish an electrical connection to the backs of the contact pins within the current collector. The needle holder preferably has no circuit board to provide a replacement element that is as cost-effective and resource-efficient as possible.

The contact needles can each have a recess at an end facing the respective electrically conductive spring pin, into which a head end of the electrically conductive spring pin projects. As a result, a mechanically stable and preferably self-centering connection can be established between spring pin and contact needle.

In one embodiment, the system may also include a rectifier. The rectifier can be set up to provide an output voltage of defined polarity based on an input voltage applied to at least two of the contact needles. The rectifier can be part of the current collector, a separate element or even part of the electrical consumer. In particular, the main body of the current collector may include the rectifier. The main body of the current collector may have a circuit board with the rectifier. The electrically conductive spring pins are preferably arranged on the same circuit board as the rectifier. For example, a bridge rectifier can be provided. Alternatively, or in addition, the rectifier can be arranged in a consumer that can be connected to the current collector. The rectifier may have a first output contact and a second output contact. In order to limit the circuitry complexity and thus the costs of the rectifier, the current collector preferably has exactly four or exactly three or exactly two contact pin needles. With exactly four contact needles, in particular, there is an advantage in limited circuitry and the ability to cover large angle ranges.

In a further development, the rectifier may have at least three inputs and (exactly) two outputs, each of the at least three inputs being connected to a respective contact needle.

The main body of the currency collector may have a holder to accommodate the needle holder. The needle holder with the contact needles may be designed to be inserted detachably into the holder of the base body. One advantage of this solution may be a simplified installation option. Preferably, only access from a lower side of the current collector, on which the tips of the contact needles are arranged, is required for replacement.

The needle holder of the current collector can be rotationally symmetrical and the base body of the current collector can have a rotationally symmetrical receptacle for the needle holder. One advantage of this solution may be that it is easier to use. The needle holder and/or the receptacle of the current collector can, for example, be designed to be 180° rotationally symmetrical and/or 90° rotationally symmetrical. Rotationally symmetrical means that the needle holder can be inserted into the holder of the needle holder in different rotational states.

The contact needles of the needle holder of the current collector can be arranged around a centrally arranged actuating element of a locking mechanism for detachably securing the needle holder to the base body. One advantage of this solution can be a particularly compact design. Alternatively or in addition, a rotationally symmetrical structure can thus be provided in a simple manner.

The current collector may also have more than two contact needles, for example at least three contact needles. In particular, the current collector can have between three and seven contact needles, in particular between three and five contact needles, in particular exactly four contact needles. This enables a high probability that at least one of the contact needles will make contact with one of the first electrical conductor tracks and at least one other will contact one of the second electrical conductor tracks. The inventors have recognized that four contact needles offer an advantageous solution between limited use of material and a high probability of contact.

The pantograph may be set up to transmit electrical power between 1 W and 250 W, in particular to transmit electrical power between 2 W and 200 W, in particular to transmit electrical power between 5 W and 150 W, in particular to transmit electrical power between 5 W and 100 W. A lower limit of the power range may be 1 W, 2 W, 5 W, 10 W or 20 W. The current collector can be set up to transmit electrical power between 1 W and 250 W, in particular between 2 W and 200 W, in particular between 5 W and 150 W, in particular between 5 W and 100 W. The lower limit of the power range can be 1 W, 2 W, 5 W, 10 W, or 20 W. An upper limit of the power range can be 250 W, 200 W, 150 W, 100 W, or 60 W. For example, at a voltage of 24 V and a current of 2.5 A, the current collector can provide a power of 60 W for an electrical consumer. However, it is also possible to use integrated half-conductor rectifiers, for example, which enable a current load of 4.5 A or even 6.3 A.

The wall element and the electrical consumer can be set up in such a way that the electrical consumer can be magnetically attached to the wall element. The electrical consumer may have a receptacle for the current collector. In particular, the electrical consumer may have a recess or depression to receive the current collector. The electrical consumer may have a plurality of magnets arranged around the recess for magnetically attaching the electrical consumer to the wall element. This solution can enable the electrical consumer to be securely fastened. Furthermore, the arrangement of the magnets around the recess for the electrical consumer can provide a uniform contact pressure of the current collector on the current-carrying wall element, in particular not on one side.

In one embodiment, the contact needles of the current collector can be arranged in such a way that, when the current collector rests on the current-carrying wall element, at least a first of the contact needles (lying on the circle) can be brought into contact with one of the first conductor tracks and a second contact needle (lying on the circle) can be brought into contact with one of the second conductor tracks, irrespective of a rotation (or alignment) of the current collector (in the circular plane or plane of the wall element) on the current-carrying wall element. It goes without saying that the contact should not be understood completely independent of the rotation but, within the scope of the present invention, as largely independent of the rotation, for example taking into account a tolerance of +−5° or +−10°, so that a contact needle does not fall in an intermediate space between two adjacent conductor tracks. Such a gap can be provided to avoid a short circuit between two neighboring conductor tracks.

In other words, the contact needles of the current collector can preferably be arranged in such a way that, regardless of a rotation of the current collector on the wall, at least one of the contact needles connects to one of the first conductor tracks (e.g. the positive terminal) and at least one other of the contact needles connects to one of the second conductor tracks (e.g. the negative pole). It is therefore possible to supply a consumer with electrical power over a wide angle range via the proposed current collector.

In one embodiment, at least one (but preferably all) of the contact needles can be designed so that a tip of the contact needle has an angle between 60° and 20°, in particular between 45° and 25°, in particular of 30°. For an angle specified as 30°, a tolerance of the value can be +10°, in particular ±5°. An advantage of this configuration may consist in good penetration of the optional covering coating and, at the same time, sufficient contact area and conductivity.

The current collector may have a plurality of at least three contact needles, a first contact needle, a second contact needle, and a third contact needle of the plurality of contact needles being arranged in such a way that they lie on a circle. The features in accordance with this further aspect can preferably be combined with features described above relating to the current collector with replaceable contact needles.

The solution known from DE 10 2011 005 735 A1 allows largely free positioning in a horizontal and a vertical direction on a current-carrying wall element. With conventional needle connectors, however, there is the problem that when the current collector is rotated relative to the current-carrying wall element, the result may be that both contact needles come to rest on one and the same electrical conductor track. For example, a current collector or an electrical consumer with a current collector cannot simply be rotated by 90°. It would be desirable to further improve the positionability and to establish an electrical contact even with different angle orientations.

The inventors have recognised that the solution proposed in DE 10 2011 075 460 A1 for wireless transmission of electrical energy offers a solution to this problem and enables largely flexible positioning of electrical loads on a wall element. In this case, it is also possible for the consumer or current collector to rotate relative to the wall element. However, the effort and costs for an extensive wireless energy supply are relatively high. Furthermore, a wireless energy supply has a relatively low efficiency.

Optionally, the current collector can have not only two contact needles but a plurality of at least three contact needles, a first contact needle, a second contact needle, and a third contact needle of the plurality of contact needles being arranged in such a way that they lie on a circle or circular arc. The proposed arrangement of the contact needles on a circular arc can create an additional degree of freedom in addition to relatively free positioning, e.g. in a horizontal and/or vertical direction, which can enable freer rotation.

As a result, the probability can be increased that at least one of the contact needles contacts one of the first electrical conductor tracks and at least one other of the contact needles contacts one of the second electrical conductor tracks. In other words, the contact of at least two contact needles with the respective conductor tracks of different polarity can be maintained for a longer period of time when rotated. Further measures to enable as free rotatability as possible are explained below by way of example.

Alternatively or in addition to the above-mentioned arrangement of the first, second and third contact needles, the first, second and third contact needles can be arranged in such a way that a first straight line through the first and the second contact needle and a second straight line through the second and third contact needles intersects at an (acute) angle.

The first, second and third contact needles of the current collector can be arranged in such a way that they form a triangle, in particular an acute-angled triangle. An acute-angled triangle is a triangle in which all angles are smaller than 90°. The three sides can, but do not have to, be of different lengths.

In a further development, the first, second and third contact needles of the current collector may be arranged in such a way that they form an isosceles, in particular an equilateral triangle.

A triangular arrangement of the first, second and third contact needles lying on the circle or circular arc, in particular for an arrangement as an approximately equilateral triangle, can enable a more flexible arrangement, in particular with regard to the rotation of the current collector on the wall element.

In one embodiment, the diameter of the circle on which the first contact pin, the second contact pin and the third contact pin lie can be less than or equal to the sum of the width of one of the first conductor tracks and the width of a (neighbouring) one of the second conductor tracks, and optionally a gap between them. One advantage of this solution may be that when the current collector rotates, different contact needles come to rest on the first or second conductor track and the contact of at least two contact needles on different conductor tracks is made possible over a larger angle range.

In one embodiment, the contact needles lying on a circle can be arranged in such a way that the first contact needle lies in a first third of the circle, the second contact needle is in a second third of the circle and the third contact needle is in a third of the circle. For example, the circle can be divided into three equally large circular sectors and one of the three contact needles can be located in each of the three circular sectors.

In one embodiment, the current collector may also have a fourth, a fifth and a sixth contact needle. In this case, the first to sixth contact needles can be arranged as a hexagon. In particular, the contact needles can be arranged as a hexagon, in particular as an equilateral hexagon or star, the contact needles each forming the corners of the hexagon or tips of the star. It goes without saying that, however, a different number of contact electrodes may also be provided, in particular four or more, five or more, six or more, seven or more, or eight or more.

In one embodiment, the current collector can be designed and the contact needles arranged in such a way that, when the current collector is attached to the wall element, at least two contact needles contact one or more of the first electrical conductor tracks and at least two of the contact needles contact one or more of the second electrical conductor tracks. This can be particularly advantageous for applications with high power requirements. As a rule, a current collector with 3 or 4 contact needles or pins is also sufficient for currents of up to 2 A. However, a higher number of contact needles can be advantageous because the current per current collector can be reduced. For example, cheaper components can be used. For example, two standard diodes of 2 A each can be cheaper than a high-power diode, which is designed for 4 A. Alternatively, several current collectors can also be used in parallel to tap the required power. Experiments have shown that, in addition to powering luminaires, it is also possible to supply screens. When several current collectors are connected together, for example in parallel, outputs of up to 3,000 watts or more are generally achievable.

In one embodiment, the contact needles can be arranged in such a way that a distance between the first contact needle and a straight line through the second contact needle and the third contact needle is greater than the width of one of the electrical conductor tracks. Alternatively or additionally, a distance between the first contact pin and a straight line through the second contact pin and the third contact pin can be less than twice the width of one of the electrical conductor tracks, as well as optionally an insulation gap between them. One advantage of this arrangement may be that rotation over a wide angle range is made possible.

In one embodiment, the current collector may have a fourth contact needle and the fourth contact needle may lie within the circle on which the first, second and third contact needles are arranged. For example, the fourth contact needle may lie at a centre of a circle or at a center point of a triangle formed by the first, second and third contact needles. One advantage of this configuration may be that the probability that an adequate electrical connection of the current collector to the conductor tracks is made possible is further improved. For example, the problem that two of the three contact needles lying on the circle fall into an insulation gap between one of the first conductor tracks and a second conductor tracks can be addressed. In a further development, the fourth contact needle may be arranged at a distance from a centre of the circle. It goes without saying that the features of this embodiment can also be combined with the features of one or more of the previous or the designs described below. A “fourth” contact needle can be understood as an additional contact needle. For example, a fourth contact needle in the context of the aforementioned arrangement as a hexagon can be understood as a first fourth contact needle and a fourth contact needle, which according to the present embodiment lies within the circle, as a second fourth contact needle or further contact needle. It goes without saying that this second fourth contact needle or further contact needle can lie within a circle on which the first, second and third contact needles are arranged, but further contact needles can also be arranged.

In one embodiment, the current collector (optionally in conjunction with a holder) can be set up so that the contact needles are movable between a contact position in which the contact needles contact the conductor tracks and a non-contact position in which the contact needles are spaced apart from the conductor tracks when the current collector is placed on the current-carrying wall element. In this case, the non-contact position can also be referred to as a shift position. Preferably, the current collector can therefore be moved on the wall element in order to reach the desired position. When the desired position is reached, the contact needles can be lowered or brought into the contact position. In one example, the current collector can have a holder, which is designed so that the contact needles are brought into contact with the conductor tracks by inserting them, for example, by inserting a consumer into the holder. For example, the contact needles are only activated when a connection element is inserted or a consumer or housing is plugged in or plugged in. One advantage may be improved positionability in the non-contact position.

In one embodiment, the current collector can be designed such that a straight line through the first and second contact needles intersects a horizontal or vertical axis of the current collector at an acute angle when the current collector is aligned horizontally or vertically (on the wall element), in particular at an angle of no more than 30°, in particular at an angle of no more than 15°, in particular at an angle of no more than 5%.

Alternatively or in addition, the system may also have an electrical consumer on which the current collector is arranged in such a way that a straight line through the first and the second contact needle when the electrical consumer (on the wall element) is oriented horizontally or vertically intersects a horizontal or vertical axis of the electrical consumer at an acute angle, in particular at an angle of not more than 20°, in particular at an angle of not more than 10°, particularly in a angle of not more than 5%.

In other words, the arrangement of the contact needles can be arranged rotated by an (acute) angle relative to the orientation of the conductor tracks. The relative position of the contact needles and housing must be taken into account. One advantage of this solution can be improved reliability when making contacts. The inventors have recognised that, particularly in shopfitting, elements that are attached to the wall are preferably attached horizontally or vertically. Angles in the range of between 25 and 65° are also frequently used. Minor twists, for example by 5° or 10°with respect to the horizontal or vertical, are, on the other hand, more likely to be perceived as unwanted tilting or misalignment. By selecting exactly such a rarely occurring angle, the probability of two contact needles lying in a line falling into an insulation gap between two neighbouring conductor tracks can be reduced.

In one embodiment, the wall element and the current collector can be set up in such a way that the current collector can be magnetically attached to the wall element. Alternatively, other fasteners or types of attachment, such as adhesives or screws, can be used. However, the use of a detachable connection is preferred to enable subsequent restructuring.

The advantages described in detail above for the first aspect of the invention may apply accordingly to the further aspects of the invention.

It is understood that the above-mentioned features and those to be explained below can be used not only in the combination indicated in each case but also in other combinations or on their own without departing from the scope of the present invention.

Exemplary forms of the embodiment are shown in the drawing and are explained in more detail in the following description. See:

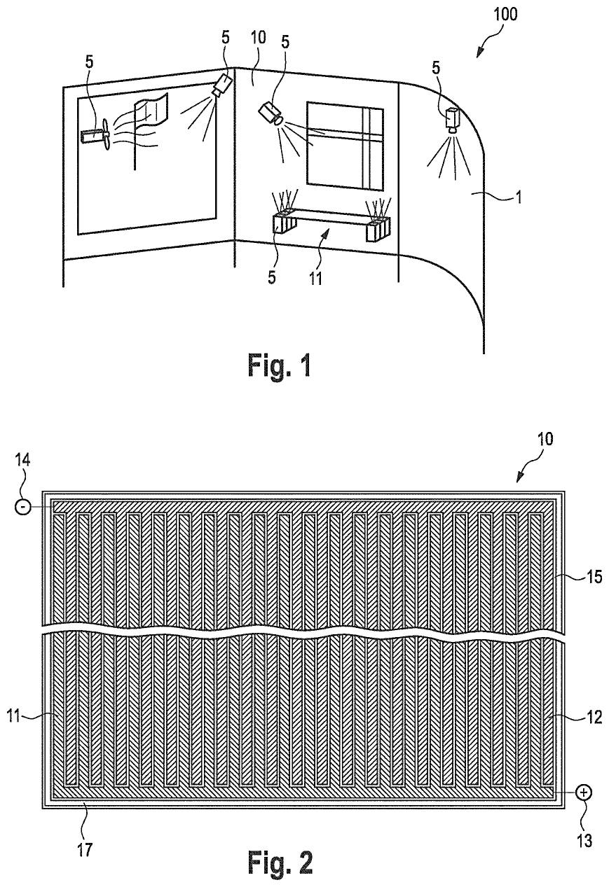

FIG. 1 an exemplary presentation stand with a system according to an embodiment example of the present disclosure with several wall elements;

FIG. 2 a schematic illustration of a wall element without coating;

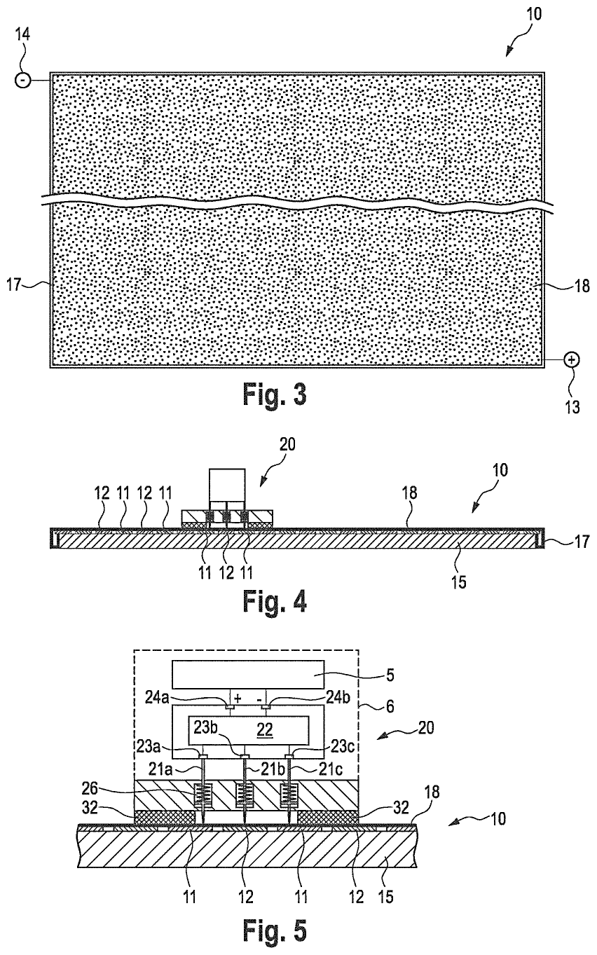

FIG. 3 a schematic illustration of a wall element with coating;

FIG. 4 a side view of a current collector attached to a wall element according to the current technology;

FIG. 5 an enlarged view of the current collector from FIG. 4;

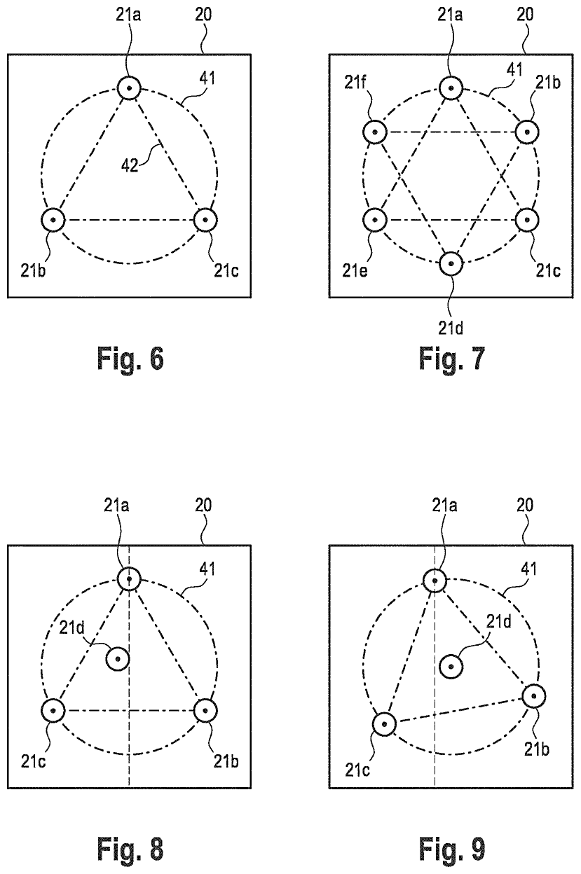

FIG. 6 a first exemplary illustration of an arrangement of contact needles on a current collector;

FIG. 7 a second exemplary illustration of an arrangement of contact needles on a current collector;

FIG. 8 a third exemplary illustration of an arrangement of contact needles on a current collector;

FIG. 9 a fourth exemplary illustration of an arrangement of contact needles on a current collector;

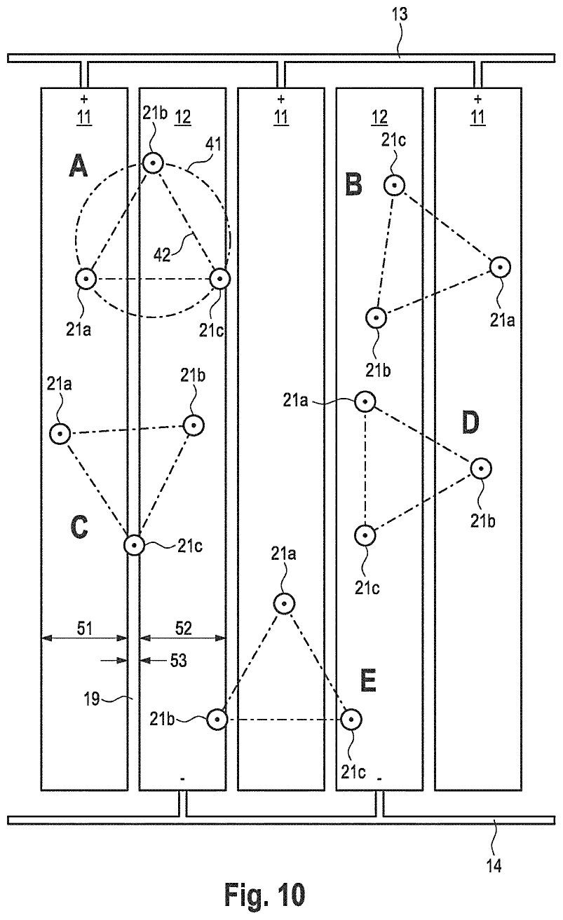

FIG. 10 an illustration of the arrangements of contact needles on a current-carrying wall element in various positions and rotations;

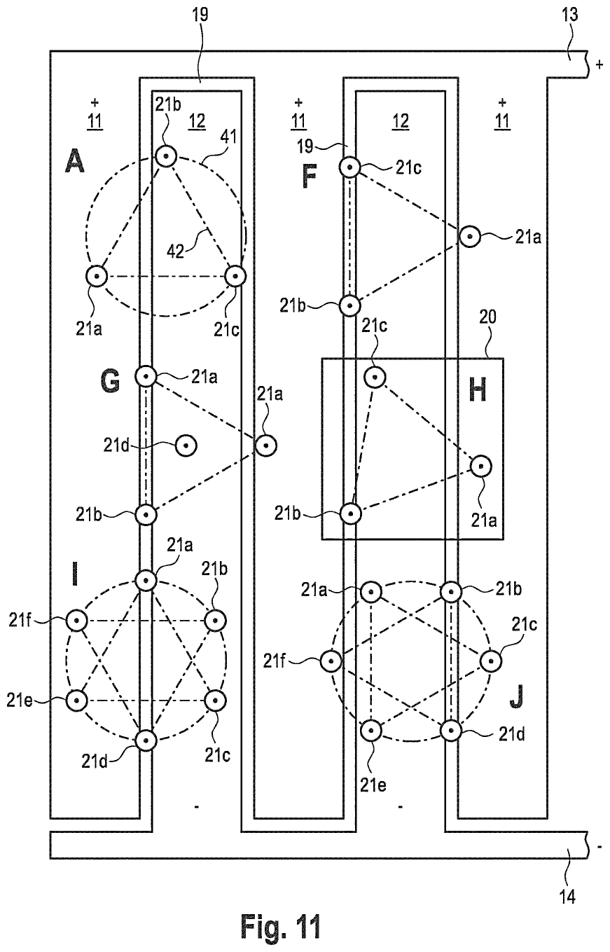

FIG. 11 a further illustration of various arrangements of contact needles on a current-carrying wall element in various positions and rotations;

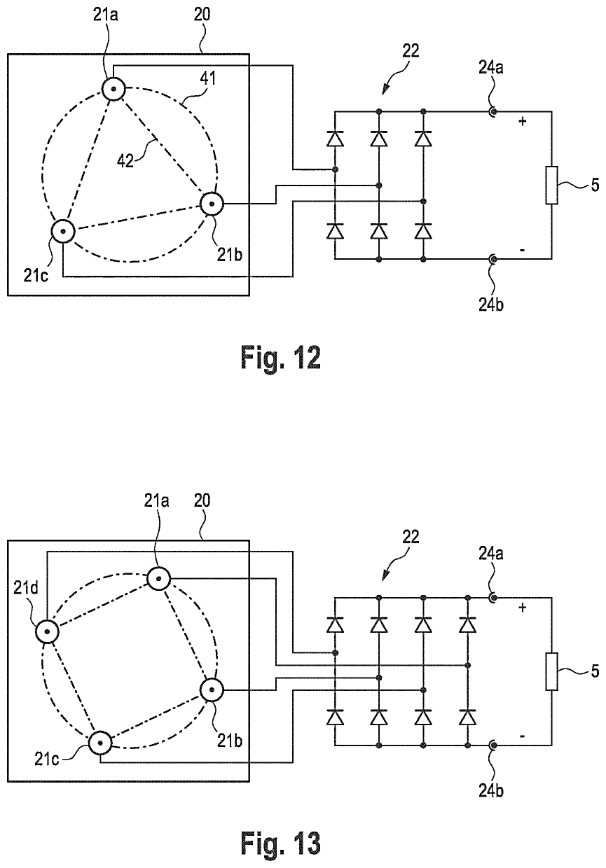

FIG. 12 shows an illustration of an arrangement of three contact needles in conjunction with a rectifier;

FIG. 13 shows an illustration of an arrangement of four contact needles in conjunction with a rectifier;

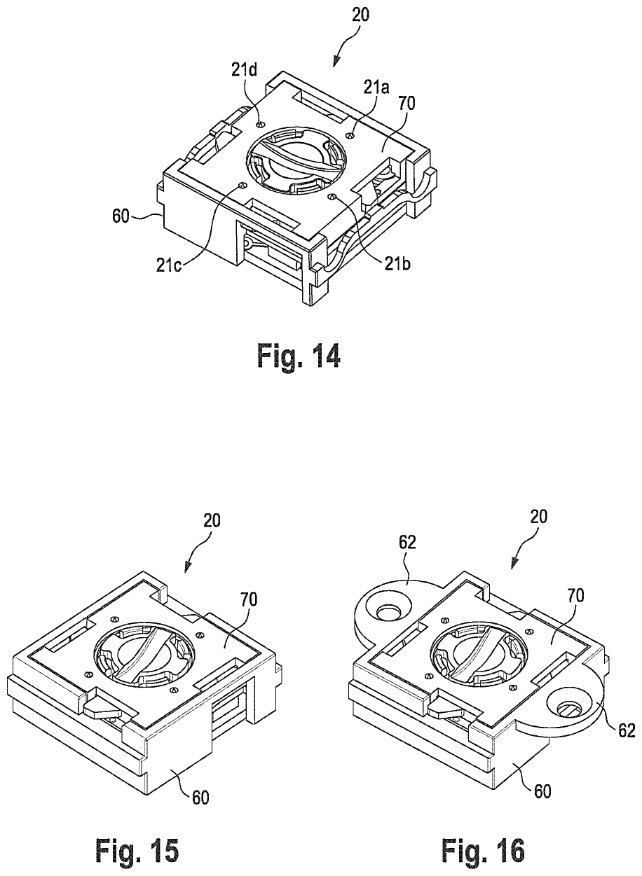

FIG. 14 shows a perspective view of a current collector in accordance with an embodiment of the present invention;

FIG. 15 shows a perspective view of a current collector in accordance with a further embodiment of the present invention;

FIG. 16 shows a perspective view of a current collector in accordance with a further embodiment of the present invention;

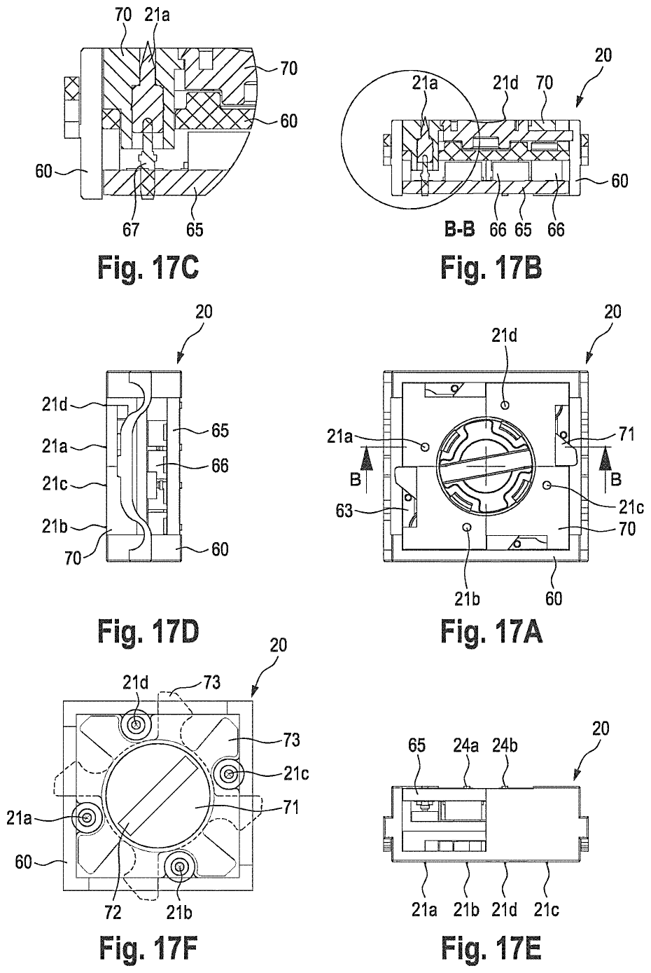

FIG. 17 through F show a top view, as well as side views and sectional views of a current collector according to an embodiment of the present disclosure;

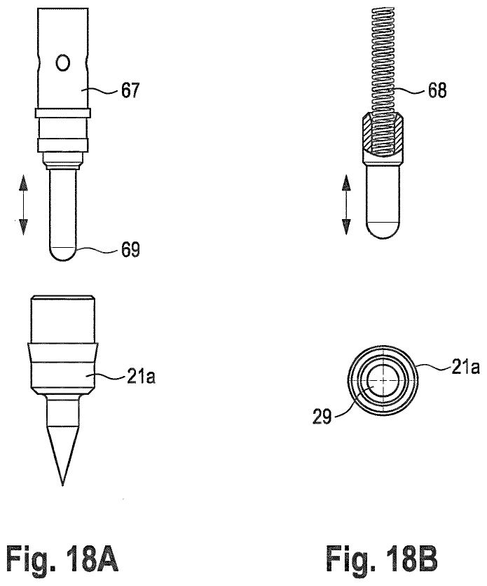

FIG. 18 and B show illustrations of contact needle and spring pin;

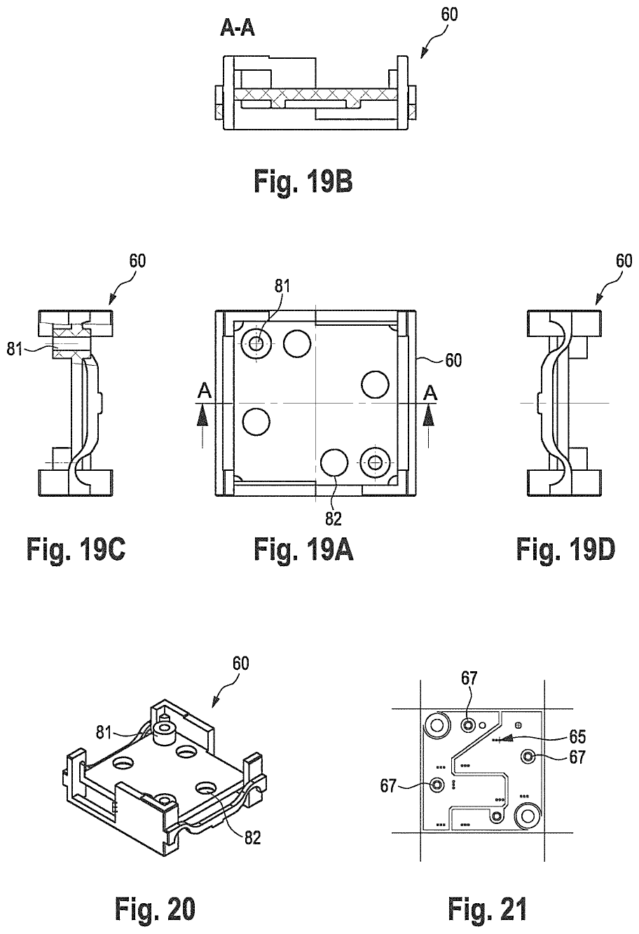

FIG. 19 through D show a top view, as well as side views and sectional views of a base body of a current collector according to an embodiment of the present disclosure;

FIG. 20 shows a perspective view of the main body of the current collector from FIGS. 19 A to D;

FIG. 21 shows a top view of a corresponding circuit board;

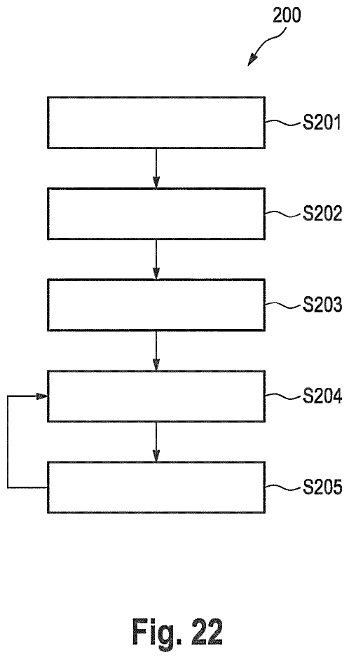

FIG. 22 shows a flow chart of a method

FIG. 1 shows an exemplary presentation stand 100 or a shop window structure with a system in accordance with an embodiment of the present invention. The presentation stand 100 comprises a plurality of wall elements 10. Various objects 5 can be attached to the wall elements 10. Various fasteners known from shopfitting or exhibition construction can be used for this purpose. In a preferred embodiment, the objects can be magnetically attached to the wall elements 10. One advantage of this solution is that the objects 5 can be positioned freely on the wall elements 10. It is also understood that corresponding floor or ceiling elements can be provided, which for the sake of simplicity are also referred to as wall elements in the context of the present invention. The objects may be electrical consumers, such as a light source, a lighting device, a screen, a motor, a loudspeaker, a shop window mannequin or similar. Current collectors are provided for the power supply, which are electrically connected to the electrical consumers 5 or can be designed as part of the objects or electrical consumers.

With the proposed wall element 10 and the associated current collector 20, presentation, sales or exhibition stands 100, in particular in modern show rooms, can be easily modified and, in particular, easily adapted to local conditions, as a result of which a high degree of flexibility with regard to the design freedom of presentation, sales or exhibition stand 100 can be achieved. Such wall elements 10 can also be used in shopfitting. In addition, the system can also be used beneficially in museums or in the smart home sector.

In particular, this does not require complex cabling of electrical consumers compared to previous exhibition stands, which not only significantly simplifies assembly and dismantling, but also allows the electrical consumers 5 to be positioned almost freely and variably. A number of wall elements 10 are usually assembled to set up the presentation, sales or exhibition stand 100.

A special feature of the proposed system may be that the current collectors 10 or the electrical consumers 5 can preferably not only be flexibly positioned on the wall elements 1 with regard to their horizontal and vertical position, but can also be rotated. For this purpose, the proposed system comprises at least one current-carrying wall element 10 and a current collector 20 for an electrical consumer 5. An embodiment of a current-carrying wall element 10 is shown in FIGS. 2 and 3. Examples of current collectors are shown in FIG. 4 and following.

FIG. 2 shows a schematic illustration of a first configuration of a wall element 10 without coating. The wall element 10 has first electrical conductor tracks 11 of a first polarity and second electrical conductor tracks 12 of a second polarity. The first and second electrical conductor tracks 11, 12 are arranged alternately or alternatingly, at least in sections. The first electrical conductor tracks 11 can form a first comb-like structure. The second electrical conductor tracks 12 can form a second, corresponding comb-like structure, the first comb-like structure and the second comb-like structure being designed in such a way that the comb-like structures interlock. An insulation gap is provided between the first and second electrical conductor tracks 11, 12. The insulation gap ensures that there is no short circuit. The width of the insulation gap is preferably as small as possible, for example less than 2 mm, in particular less than 1.5 mm, in particular less than 1.0 mm, in particular less than 0.5 mm, in particular less than 0.2 mm. The width of the insulation gap may be less than 1/10, in particular less than 1/20 of a width of the conductor tracks. This makes it possible to reduce the probability that one of the contact needles falls into the insulation gap. However, the insulation gap can be selected to be larger than the width of a tip of a contact needle of a current collector in order to avoid a short circuit between the conductor tracks 11 of the first polarity and the conductor tracks of the second polarity 12. The conductor tracks 11 of the first polarity are set up to be connected to a first output of a voltage source, for example a positive pole 13. The conductor tracks 12 of the second polarity are set up to be connected to a second output of a voltage source, for example a negative pole 14. Instead of a DC voltage, the conductor tracks 11, 12 can also be supplied with an AC voltage or with a combination of DC and AC voltage. At least 70%, in particular at least 85%, in particular at least 90% or 95% of an area of the current-carrying wall element can be covered by the first and second conductor tracks. The conductor tracks 11, 12 can be part of a carrier element 15 of the wall element 10 or, alternatively, be applied to the carrier element 15.

FIG. 3 shows a schematic illustration of a wall element 10, which optionally has a cover 18. For example, the coating 18 can cover the conductor tracks 11, 12 applied to the carrier plate 15. Alternatively, the conductor tracks 11, 12 can be designed as part of the coating. In this case, the conductor tracks may have, for example, the same or similar geometry as the conductor tracks described above and shown in FIG. 2. To attach the cover 18 to the wall element 10, an edge piping rail 17 (or a piping profile) can be provided, into which, for example, a piping strip on the cover side is inserted. The piping strip can be made of silicone or aluminum, for example.

FIG. 4 shows a side view of a system with a wall element 10 and a current collector 20 attached to the wall element 10. FIG. 5 shows an enlarged view of the current collector 20 from FIG. 4 on the wall element 10. The wall element 10 has a carrier plate 15 and, optionally, a cover 18 covering it. The wall element 10 also has first electrical conductor tracks 11 of a first polarity and second electrical conductor tracks 12 of a second polarity, with the first and second electrical conductor tracks 11, 12 being arranged alternately at least in sections.

The current collector 20 has a plurality of at least two, in particular of at least three contact needles 21a, 21b, 21c. The current collector 20 is set up to be fastened to the wall element 10 in such a way that at least one of the contact needles 21a contacts one of the first electrical conductor tracks 11 and at least one other of the contact needles 21b contacts one of the second electrical conductor tracks. In this case, a first contact needle 21a, a second contact needle 21b, and a third contact needle 21c of the plurality of contact needles can be arranged in such a way that they lie on a circle, as explained in more detail below with reference to FIG. 6 and onwards. In current collectors known from the state of the art for a presentation, sales or exhibition stand and/or for shopfitting with a current-carrying wall element, the current collector being designed to be attached to the wall element, the wall element having a carrier plate and a cover covering it, the contact needles are not designed to be replaceable.

In order to attach the current collector 20 to the wall element 10, the wall element 10 and the current collector 20 can be arranged in such a way that the current collector can be magnetically attached to the wall element. For example, as shown in FIGS. 4 and 5, the current collector 20 may have one or more magnets 32. The conductor tracks 11, 12 and/or the carrier plate can have a magnetic material so that the current collector can stick to it.

The contact needles 21a-c of the current collector can be connected to a rectifier 22. The rectifier may be part of the current collector or part of an electrical consumer 5 which can be connected to the current collector. The rectifier 22 is designed to provide an output voltage of defined polarity based on an input voltage applied to at least two of the contact needles 21a-c. Output pins 24a, 24b can be provided for this purpose, to which an electrical consumer 5 can be connected. The rectifier can have at least three inputs 23a-c and two outputs 24a, b, each of the at least three inputs 23a-c being connected or connectable to a respective contact needle 21a-c. Exemplary embodiments of such rectifiers in the form of bridge rectifiers are shown in FIGS. 12 and 13. The rectifier 22, the current collector 20 and the electrical consumer 5 can optionally form a unit 6. Optionally, the current collector 20 and the rectifier 22 can be part of the electrical consumer 5.

It goes without saying that the current collector or the contact needles can optionally have a contact spring 26 for the contact needles, as in FIG. 5, in order to provide a defined contact pressure.

FIGS. 6 to 9 show exemplary illustrations of arrangements of contact needles 21a-f on a current collector 20. The current collectors 20 each have a plurality of at least three contact needles 21a-21f, a first contact needle 21a, a second contact needle 21b, and a third contact needle 21c of the plurality of contact needles 21a-21f being arranged in such a way that they lie on a circle 41. The circle 41 is shown in dashed auxiliary lines, as this is only intended to describe the type of arrangement.

In the example shown in FIG. 6, the current collector 20 has three contact needles 21a-c, the first, second and third contact needles 21a-21c of the current collector 20 being arranged in such a way that they form a triangle 42, in particular an acute-angled triangle, in particular an isosceles triangle, and in particular an equilateral triangle.

FIG. 10 shows an illustration of the current collector shown in FIG. 6 and its contact needle arrangement in various positions and rotations A to E. The first electrical conductor tracks 11 and second electrical conductor tracks 12 of the wall element 10 are shown in the background. The current collector 20 (more precisely its contact needle arrangement) is arranged to be attached to the wall element in such a way that at least one of the contact needles 21a contacts one of the first electrical conductor tracks 11 and at least one other of the contact needles 21b, 21c contacts one of the second electrical conductor tracks 12. As can be seen from FIG. 10, even with a large number of different rotational states, at least one of the contact needles can always be in contact with one of the first electrical conductor tracks 11, in this case the positive pole, and at least one of the contact needles can be in contact with one of the second electrical conductor tracks 12, in this case the negative pole. This is true even if, as shown in position C, one of the contact needles 21c is located in an insulation gap 19 between the conductor tracks 11, 12.

In this case, a diameter of the circle 41 (see FIG. 6), on which the first contact needle, the second contact needle and the third contact needle lie, may be less than equal to the sum of a width 51 of one of the first conductor tracks 11 and a width 52 of the second conductor tracks 12 and, optionally, a width 53 of the insulation gap 19 in between. As shown in FIG. 10 at position E, two contact needles 21b, 21c can also lie on different conductor tracks 12 of the same polarity, with a third of the contact needles 21a lying on a conductor track 11 of the other polarity. Optionally, the contact needles 21a-c can be arranged in such a way that a distance between the first contact needle 21a and a straight line through the second contact needle 21b and the third contact needle 21c is greater than a width 51, 52 of one of the electrical conductor tracks 11, 12.

The following table shows exemplary combinations of conductor track widths and circle diameters 41. An insulation gap with a width of 1 mm and a contact surface of the contact needles of 0.5 mm were assumed. The first and second conductor tracks 11, 12 can have the same conductor track width.

| Conductor track width in mm | Circle diameter |
|---|---|
| 9 | 16-17 |
| 10 | 17-19 |
| 11 | 18-21 |
| 14 | 22-27 |
| 15 | 24-29 |
| 19 | 29-37 |
| 20 | 30-39 |

FIG. 11 shows a further illustration of various arrangements of contact needles on a current-carrying wall element in various positions and rotations. In a particularly unfavourable case, however, as shown in FIG. 11 position E, the second contact pin 21b and the third contact pin 21c, for example, can fall into the insulation gap 19 between the conductor tracks 11, 12. In this special case, a power supply would not be possible without further assistance. A first possible solution is to combine a first and a second current collector with different rotational orientations of the contact needles 21a-21c, for example with the orientations shown in FIG. 11 position A and position B. However, this would involve a significant use of materials.

FIG. 11 positions G to J show further exemplary solutions. As shown in FIGS. 8 and 9, as well as FIG. 11 position G, the current collector 10 can optionally have a fourth contact needle 21d. The fourth or further contact needle 21d may lie within the circle 41 on which the first, the second and the third contact needles 21a-c are arranged. It is understood that such a further contact needle can also be provided within the circle in combination with further contact needles, as shown in FIG. 7, for example. As a result, the flexibility with regard to the free positioning and rotation of the pantograph relative to the wall element can be further improved. In the examples shown in FIG. 9 and FIG. 11g, the fourth contact pin can be located in a centre of the circle 41 and/or in a centre of gravity of the triangle 42 (whereby these points coincide for an equilateral triangle). Optionally, the fourth contact needle 21d

Optionally, the fourth contact needle 21d can be arranged at a distance from a center of the circle 41, as shown in FIG. 8. This has the advantage that it reduces the probability that, for example, the contact needles 21a and 21d lie in a straight line 43 which runs parallel to a horizontal or vertical axis of the current collector 20. The inventors have recognised that the current collectors 20 are often arranged in a horizontal or vertical orientation. Against this background, it may be advantageous to arrange the contact needles rotated to a horizontal or vertical axis of the current collector 20, as shown in FIG. 9 and FIG. 11 position H. This also has the advantage that it reduces the probability that, for example, the contact needles 21a and 21d lie in a straight line 43 which runs parallel to a horizontal or vertical axis of the current collector 20. The use of a quarter contact needle 21d is optional here. In particular, exactly three contact needles can be provided in this case, so that costs and manufacturing costs can be further reduced.

In a further embodiment, the current collector 20 may also have a fourth contact needle 21d, a fifth contact needle 21e and a sixth contact needle 21f. The six contact needles 21a-f can be arranged as a hexagon, in particular as an equilateral hexagon or star. As in the examples shown in FIG. 11 positions I and J, in this case, even if two contact needles 21a and 21d, as shown in FIG. 11 position I, or 21b and 21d, as shown in FIG. 11 in position J, fall into the insulation gap 19, an electrical connection can still be established with one of the first conductive tracks 11 and one of the second conductive tracks 12. Another advantage of this configuration may be that, when the current collector 20 is attached to the wall element 10, at least two contact needles 21e, 21f contact one or more of the first electrical conductor tracks 11 and at least two of the contact needles 21b, 21c contact one or more of the second electrical conductor tracks 12. This can enable higher current flows and therefore higher outputs of an electrical device 5 connected to the current collector 20.

FIG. 12 shows an illustration of a current collector 20 with an arrangement of three contact needles 21a-21c in conjunction with a rectifier 22. FIG. 13 shows a corresponding illustration of a current collector 20 with an arrangement of four contact needles 21a-21d in conjunction with a rectifier 22. In the examples shown, a diode bridge rectifier is shown, but other types of rectifiers can also be used. One advantage of this solution is a simple, cost-effective design, which is also easily scalable for a larger number of contact needles 21a-f. An output voltage of defined polarity is provided at the outputs 24a, 24b, which can be supplied to an electrical consumer 5.

FIG. 14 shows a perspective view of a current collector 20 according to an embodiment example of the present invention for an electrical consumer. Such a current collector may also be referred to as a needle connector. Further embodiments of current collectors 20 according to further embodiments of the present disclosure are shown in the perspective views in FIG. 15 and FIG. 16.

The current collector 20 has a base body 60 and a needle holder 70. In this case, the needle holder 60 has the contact needles 21a-21d. It is true that the current collector 20 can be designed in such a way that the contact needles 21a-21d can also be replaced individually. Preferably, however, a needle holder 70 is provided, which has the contact needles 21a-21d and wherein the contact needles can be exchanged as a group together with the needle holder 70. This makes handling easier. At the same time, a sustainable solution is provided, since it is not necessary to replace the entire current collector 20 but only the needle holder 70 can be replaced. The base body 60 of the current collector 20 can have a holder for receiving the needle holder 70, the needle holder 70 being designed to be inserted detachably into the holder of the base body 60. In the perspective view in FIG. 14, the needle holder 70 can be inserted, in simple terms, from above into the base body 60.

Further details of the exemplary current collector 20 of FIG. 14 are explained below with reference to the illustrations in FIGS. 17a to f. Here, FIG. 17a shows a top view of the current collector 20. FIG. 17b shows a sectional view through the current collector 20 in the sectional plane labelled B-B in FIG. 17a. FIG. 17c shows an enlarged section of FIG. 17b.FIG. 17d and FIG. 17e each show lateral illustrations of the current collector 20 from FIG. 17a.

The current collector 20 may have a locking mechanism 71 for detachably securing the needle holder 70 to the base body 60. FIG. 17f shows the locking mechanism 71 in two different positions. In the position shown by broken lines, the locking mechanism 71 is locked. The locking mechanism 71 can be designed as a type of impeller, with radially outwardly projecting wing elements 73 (see FIG. 17f) engaging in corresponding recesses 63 (see FIG. 17a) of the base body 60 and cause the needle holder 70 to be locked or fastened to the base body 60 there. For operation, the locking mechanism can have a screw cap, in particular, the screw cap can have a slot-shaped recess 72 for operation. In particular, such a needle holder 70 can be attached to the base body 60 without tools.

As shown in FIG. 17e, the contact needles 21a-21d can be arranged on a lower side or first housing side and the power connections 24a, 24b can be arranged on an upper side or a second (opposite) housing side. For example, the rectifier circuit 20 shown in FIG. 13 can be integrated into the current collector 20. This makes it possible to provide a compact, easy-to-handle component.

The base body 60 may have a circuit board 65. The circuit board 65 may have the rectifier, as shown by way of example by the schematically shown diodes or semiconductor components 66 in the sectional view in FIG. 17b and the side view in FIG. 17.

With reference to FIG. 17b and the enlarged section as shown in FIG. 17c, the current collector 20 may have electrically conductive spring pins 67. The electrically conductive spring pins 67 are preferably arranged on the same circuit board as the rectifier. This enables a simple and cost-effective design. The electrically conductive spring pins 67 are designed to provide an electrical connection between the contact needles 21a-21d of the needle holder 70 and electrical contacts 24a, 24b of the base body 60. In the exemplary embodiment shown, a bridge rectifier, as shown in FIG. 13, can preferably be interposed in order to provide an output voltage of defined polarity.

FIG. 18a and FIG. 18b show further illustrations of an electrically conductive spring pin 67 of the base body 60 of a contact needle 21a of the needle holder 70. The electrically conductive spring pins 67 can be designed to provide, on the one hand, the electrically conductive connection between contact needle 21a and circuit board 65. In addition, the current collector 20 can be set up in such a way that the electrically conductive spring pins 67 also provide contact pressure between base body 60 and needle holder 70 in a locked state of the locking mechanism 71. This allows the lock to be additionally secured when locked.

As shown in FIG. 18a and FIG. 18b, the contact needles 21a-21f can each have a recess 29 at an end facing the respective electrically conductive spring pin, into which a head end 69 of the electrically conductive spring pin 67 projects. This makes it possible to provide additional lateral guidance. In particular, this makes it easier to insert the needle holder 70 into the base body 60.

FIG. 15 and FIG. 16 show further exemplary embodiments of current collectors 20 with different designs of base body 60 and needle holder 70. For example, the base body 60 may have mounting elements 62 for attachment to an electrical consumer, as shown in FIG. 16.

In the example shown, the current collector has four contact needles, which can be arranged similar to the illustration shown in FIG. 12, for example. However, other arrangements or numbers of contact needles may also be provided. In particular, the current collector 20 can be designed in such a way that a straight line through the first and second contact needles 21a, 21b when the current collector is oriented horizontally or vertically intersects a current collector at an acute angle, in particular at an angle of not more than 30°, in particular at an angle of not more than 15°, in particular at an angle of not more than 5%. This reduces the probability of several contact needles falling into a space between a 1st and 2nd conductor track when the current collector is aligned horizontally or vertically on a current-carrying wall element.

In order to better represent and differentiate the base body 60 from the other elements of the current collector 20, further illustrations of the base body 60 from FIG. 17 are shown separately again in FIG. 19a-d and FIG. 20. FIG. 19a shows a top view of the base body 60. FIG. 19b shows a sectional view in the plane A-A from FIG. 19a. FIG. 19c shows a further sectional view through a borehole or screw hole 81 in order to screw the base body to the circuit board 65. An exemplary circuit board 65 for the base body is shown separately in FIG. 21. This also shows the electrically conductive spring pins 67 on the circuit board 65, which, when assembled, can carry through corresponding openings 82 of the base body 60.

FIG. 22 shows a flow diagram of a process 200, in particular for a presentation, sales or exhibition stand 100 and/or for shopfitting. In a first step S201, a current-carrying wall element, as described in the context of the present disclosure, is provided. In a second step S202, a current collector, as described in the context of the present disclosure, is provided, the current collector 20 having replaceable contact needles 21a-21f. In a third step S203, the replaceable contact needles can be replaced. This may be necessary in particular if one or more of the contact pins have been bent or otherwise damaged during previous use of the current collector. In a fourth step S204, the current collector is attached to the current-carrying wall element in such a way that a first of the contact needles contacts one of the first electrical conductor tracks and at least one other of the contact needles makes contact with one of the second electrical conductor tracks.

In an optional further step S205, the position and rotation of the current collector (or of an electrical load comprising the current collector or connected to the current collector) can be checked and the position and/or rotation of the current collector can be corrected. Step S205 can optionally be repeated iteratively until a desired position and rotational orientation is achieved. It goes without saying whether step S203 can also be repeated several times over the lifetime in order to always establish a perfect electrical contact. This can further improve the flexibility in the assembly and design of such a presentation system. In particular, it is not necessary to determine a position and an angular orientation of the electrical consumers in advance, as these can be flexibly adjusted.

With the proposed solution, it is no longer necessary to replace the current collector as a whole. In the embodiment shown by way of example, the needle holder 70 can be released and removed from the current collector, for example with the aid of a coin, whereby the needle holder in the present example contains all four contact needles or their tips. Due to the design of the spring pins, the needle holder is lifted after the lock is released for easier removal. The electrically conductive spring pins can therefore also be designed to raise the needle holder 70 relative to the base body 6) for easier removal. This part is then replaced by a new part, which is turned back in with the coin. The needle holder is preferably designed to be rotationally symmetrical. Optionally, a corresponding receptacle of the base body 60 can also be designed to be rotationally symmetrical. Incorrect insertion is virtually impossible, meaning that an exchange can also be carried out in a simple way. As a result, a circuit board of the base body with the electronic circuit located on it can continue to be used and only a small plastic part with 4 needle tips can be replaced.

It goes without saying that the embodiments described here by way of example can also be used in modified form, for example with a different number of contact needles, different dimensions, different distances between contact needles and surfaces and/or modifications of the geometric arrangement.

It goes without saying that the strictly vertically or horizontally oriented arrangements of the conductor tracks shown, as shown in FIG. 2, for example, are to be understood as examples, so that they can also be arranged thinner, thicker, obliquely or otherwise, such as circular or meander-shaped, on the carrier element 15. To operate the electrical consumer 5, the current collector can interact with the conductive tracks arranged on the carrier element in such a way that at least a first contact needle can make electrical contact with one of the first conductive tracks and a second contact needle can make electrical contact with one of the second conductive tracks. In particular, low-voltage systems can be used for the power supply, which operate at 12/24/48 V and can therefore be used safely. However, it is also possible to use higher-voltage systems, i.e. systems with higher voltage, through special insulators, which are applied as paint, film and/or other materials. Due to the needle-shaped design of the contact needles, for example, they can be moved almost as often as required without damaging the coating 18. In general, the conductor paths 11, 12 usually carry low current, for example 12 or 24 or 48 V, so that a risk of injury when handling the proposed wall element 10 or the current collector 20 or an electrical consumer 5 connected to it can also be virtually ruled out. The conductor tracks 11, 12 can be applied to the carrier plate 15, for example, by spraying, gluing or welding. In particular, conductive paints which are sprayed/printed onto the carrier plate 15 (for example by screen printing) can also be used for the conductor tracks 11, 12.

It is also possible that the wall elements 10 can not only be made flat but can also be curved or arched. Modern magnets 6 enable magnetic forces of significantly more than 80 kg, so that even large electrical consumers 5 or electrical consumers 5 arranged in special presentation elements, such as shelves 11 (see FIG. 1), can simply be fixed to the respective wall elements 10.

The wall element 10 can also be designed flexibly, in particular can be rolled up or unrolled, so that it can be used, for example, as wallpaper or floor covering. In this case, the wall element 10 can be constructed as a sandwich material, which contains the current-carrying conductor tracks 11, 12 and can be used or mounted/applied, for example, as wallpaper/carpet (rolled goods) or plate material.

Sandwich construction can be carried out as follows: The coating 18 (surface material) is designed as a thin, penetrable, flexible material, behind which the conductor tracks 11, 12 are arranged on an insulating material, behind which the carrier material 15 is made of plastic and/or magnetic or magnetisable material, such as steel.

The current collector 20 and/or the electrical consumer 5 can also be intelligent or programmable. Data can be transmitted by modulating a signal onto one or both of the conductor tracks 11, 12 by means of so-called powerline communication (PLC) or by means of wireless communication or optically. For example, various current collectors 20 and/or electrical consumers 5 can be controlled in a targeted manner. For example, shifting/dimming/controlling individual consumers 5 is possible. Furthermore, a bus system can also be provided in which the electrical conductor tracks 11, 12, the current collectors 20 and/or the electrical consumers 5 form part of the bus system and with which individual consumers can be addressed/controlled individually.

Optionally, a wall element can also be set up to be applied under a wall covering, such as fibreglass wallpaper, and can be used, for example, in the smart home sector or in a museum, where the current collectors can be used to supply electrical loads, such as lighting devices for pictures or other exhibits or monitors explaining the exhibits, with electrical energy.

The proposed system can also be used in an office or a private household, where it can then be arranged, for example, under a surface made of textile, foil or wood veneer or other wall surface materials. The current collectors make it possible to flexibly supply electrical consumers with power at different positions and, in particular, at different angles of rotation, without having to provide a large number of possibly unsightly power outlets. Particularly when using a low-voltage system, safety for children or other persons can thus also be improved while at the same time increasing flexibility.

1. A system, comprising:
a current-carrying wall element; and
a current collector for an electrical consumer, which is designed to be attached to the wall element,
wherein the wall element comprises a carrier plate and a coating covering it,
wherein the wall element has first electrical conductor tracks of a first polarity and second electrical conductor tracks of a second polarity, wherein the first and second electrical conductor tracks are arranged alternately at least in sections,
wherein the current collector comprises a plurality of at least two contact needles,
wherein the current collector is set up to be attached to the wall element in such a way that at least one of the contact needles contacts one of the first electrical conductor tracks and at least one other of the contact needles contacts one of the second electrical conductor tracks, and
characterised in that the current collector has replaceable contact needles.

2. The system according to claim 1, wherein the current collector has a base body and a needle holder; wherein the needle holder has the contact needles, and wherein the needle holder can be replaced with the contact needles.

3. The system according to claim 2, wherein the current collector has a locking mechanism for releasably fastening the needle holder to the base body.

4. The system according to claim 3, wherein the locking mechanism comprises a twist lock; in particular wherein the twist lock comprises a slot-shaped recess for actuation.

5. The system according to claim 2, wherein the current collector is set up in such a way that the needle holder can be attached to the base body without tools.

6. The system according to claim 5, wherein the current collector comprises electrically conductive spring pins which are designed to provide an electrical connection between the contact needles of the needle holder and electrical contacts of the base body.

7. The system according to claim 6, wherein the electrically conductive spring pins are further arranged to raise the needle holder relative to the base body for easier removal.

8. The system according to claim 7, wherein the base body has a printed circuit board on which the electrically conductive spring pins are arranged.

9. The system according to claim 6, wherein the contact needles each have a recess at an end facing the respective electrically conductive spring pin into which a head end of the corresponding electrically conductive spring pin projects.

10. The system according to claim 1, wherein the main body comprises a circuit board with a rectifier configured to provide an output voltage of defined polarity based on an input voltage applied to at least two of the contact needles.

11. The system according to claim 10, wherein the rectifier has at least three inputs and two outputs, each of the at least three inputs being connected to a respective contact pin.

12. The system according to claim 2, wherein the base body of the current collector has a receptacle for receiving the needle holder, and the needle holder with the contact needles is designed to be detachably inserted into the receptacle of the base body.

13. The system according to claim 2, wherein the needle holder is rotationally symmetrical and wherein the base body has a rotationally symmetrical receptacle for the needle holder.

14. The system according to claim 9, wherein the contact needles of the needle holder are arranged around a centrally arranged actuating element of the locking mechanism for releasably fastening the needle holder to the base body.

15. The system according to claim 6, wherein the current collector has at least three contact needles.

16. The system according to claim 1, wherein the wall element and the electrical consumer are set up in such a way that the electrical consumer can be magnetically attached to the wall element, and wherein the electrical consumer has a receptacle for the current collector.

17. The system according to claim 16, wherein the electrical consumer has a recess to receive the current collector, and wherein the electrical consumer comprises a plurality of magnets arranged around the recess for magnetically attaching the electrical consumer to the wall element.

18. The system according to claim 9, wherein the contact needles of the current collector are arranged in such a way that, when the current collector rests on the current-carrying wall element independently of a rotation of the current collector on the current-carrying wall element, at least a first one of the contact needles can be brought into contact with one of the first conductor tracks and a second one of the contact needles can be brought into contact with one of the second conductor tracks.

19. The system according to claim 18, wherein at least one of the contact needles is designed such that a tip of the contact needle has an angle of between 60° and 20°.

20. A current collector with a current-carrying wall element, wherein the current-carrying wall element comprises a carrier plate and a coating covering it; wherein the current-carrying wall element has first electrical conductor tracks with a first polarity and second electrical conductor tracks with a second polarity, wherein the first and second electrical conductor tracks are arranged alternately at least in sections;
wherein the current collector is for an electrical consumer, which is configured to be attached to the current-carrying wall element;
wherein the current collector has a plurality of at least three contact needles,
wherein the current collector is configured to be attached to the current-carrying wall element in such a way that at least one of the contact needles contacts one of the first electrical conductor tracks and at least one other of the contact needles contacts one of the second electrical conductor tracks; and
wherein a first contact needle, a second contact needle, and a third contact needle of the plurality of contact needles are arranged such that they lie on a circle.

21. Use of the current collector according to claim 20 in he system according to claim 1.

22. A method, comprising the steps:
providing a current-carrying wall element;
providing a current collector for an electrical supply consumer who is set up to be attached to the wall element;
wherein the current-carrying wall element comprises a carrier plate and a coating covering it;
wherein the current-carrying wall element has first electrical conductor tracks of a first polarity and second electrical conductor tracks of a second polarity, the first and second electrical conductor tracks being arranged alternately at least in sections;
wherein the current collector has a plurality of at least two contact needles, in particular at least three contact needles,
wherein the current collector is set up to be fastened to the current-carrying wall element in such a way that at least one of the contact needles contacts one of the first electrical conductor tracks and at least one other of the contact needles contacts one of the second electrical conductor tracks;
wherein the current collector comprises replaceable contact needles; and
changing the replaceable contact needles; and
attaching the current collector to the current-carrying wall element in such a way that a first of the contact needles contacts one of the first electrical conductor tracks and at least one other of the contact needles contacts one of the second electrical conductor tracks.
